(19) United States
(12) Patent Application Publication
(10) Pub. No.: US 2015/0356559 A1
(43) Pub. Date: Dec. 10, 2015

(54) METHOD, SYSTEM AND COMPUTER PROGRAM TO BROKER THE MONETIZED BROADCASTS OF USERS THROUGH A SUBSCRIPTION BASED INFORMATION ECOSYSTEM

(71) Applicants: Dinesh BHATIA, (US); MY MANISKU PTE LTD, Singapore (SG)

(72) Inventors: Dinesh BHATIA, Singapore (SG); Dominic MORRIS, Singapore (SG)

(21) Appl. No.: 14/440,351

(22) PCT Filed: Nov. 4, 2013
(86) PCT No.: PCT/SG2013/000474

§ 371 Date: May 2, 2015

(30) Foreign Application Priority Data
Nov. 5, 2012 (SG) 201208127-9

(51) Int. Cl. G06Q 20/40; G06Q 20/12

(52) U.S. Cl. CPC G06Q 20/405; G06Q 20/127

(57) ABSTRACT

A method, system and computer program that comprises an ecosystem for the commercial distribution of information. The system is a brokerage-based publishing and subscription messaging system, utilizing novel information and payment flows between users and the system.

### FIELD OF THE INVENTION

This invention relates to the field of a publish-subscribe (Pub-Sub) System within an information brokerage ecosystem. More particularly this invention relates to a system and method for users with information to commercially distribute it to a closed set of other users who have paid to receive information from that user. The System takes the role of broker to manage the transactions of information and money between users. The System disassociates Pub-Sub user relationships from financial transactions in order to operate with payment processors that allow termination of recurring payment flows outside of this System.

### BACKGROUND OF INVENTION

The Publish-Subscribe field would constitute the most useful way to consider this invention. In order for individuals to make decisions they invariably need first to be informed, this invention affords the individual tools and resources to make themselves more aware of current information that may ultimately play a part in their decision making process.

Various forms of the Publish-Subscribe model exist; many are orientated towards receiving predetermined event notifications and are disinterested in the user who sends the information. These predetermined event notifications are selected in advance in order to inform the user when said predetermined events happen. A message broker is typically used to insure that the message is from a valid source and that those receiving it are entitled to do so.

The core of the Publish-Subscribe model is that it is a notification service, enabled through a communication medium, where the end user receives a predetermined set of information from those that they have actively subscribed to receive content from. Through the Publish-Subscribe model the Publisher information is disseminated asynchronously to active subscribers, usually in the form of a notification message.

Today the Publish-Subscribe system is used widely in differing fields of information delivery—stock market data updates, online marketing offerings, purchase and delivery tracking, RSS web feeds and many others. The continued use of the system is based on the advantages received from all users of a loosely coupled system of distributed components that is very efficient at disseminating information in a timely and efficient manner.

The Publish-Subscribe system differs from a database only system because the Publish-Subscribe system is enabled for the transmission and dissemination of information notifications from publishers to subscribers both in the present and the future. This contrasts with that of a database model where the user performs a query of information that is at that time available on the database.

The main entities on a Publish-Subscribe system are the publisher & subscriber of content. A publisher detects an event and then publishes the event in the form of a notification. A notification encapsulates information pertaining to an observed event; therefore a notification message denotes that an observed event has occurred.

After the publication of a notification it then falls on Publication-Subscribe system to deliver the message to the subscribers. Subscribers are those who have earlier expressed interest in receiving notifications of a set of events that meet their preselected requirements.

The delivery of the notifications can take many forms including, those broadcast over a closed network, those sent directly from publishers to subscribers on a one-to-one basis, those messages routed through a broker who in turn forward the messages on to active subscribers and also where a message is delivered through a network of brokers.

A traditional example of a publish-subscribe system would be a magazine that periodically publishes to a number of subscribers. The advent of digital publishing and payment has allowed for more complex forms of this traditional model. It is one of these more complex forms to which this invention relates.

### SUMMARY OF INVENTION

The object that this invention seeks to fulfill is to democratize and monetize the flow information in a novel way that empowers and enriches its users and contributors. Accordingly the invention seeks to create an ‘Information Ecosystem’ where the System operates in the role of ‘information broker’ wherein it collects fees from certain users for access to the information other users within the ecosystem who have elected to broadcast it. This ‘Monetized Broadcast’ of information is then disseminated in the form of a pushed notification, but may not limited to this form of distribution, between a Publisher of said information and the Subscriber(s) who have paid to have access to the said information.

The System utilizes novel information and payment flows in order to monetize and incentivize the Information Ecosystem, allowing for smooth and optimized transfer of information between those who seek to profit from the transmission of their information to a wider audience and those who seek to be a recipient of information that they value. Another object of the System is to facilitate and manage the information and payment flows between the users and the System, creating a stable and trusted system where all information and monetary transactions are reliable executed and maintained.

Users within the System may at various times equally adopt the role of ‘Publisher’ of information, a verified ‘Subscriber’ to another Publishers information broadcasts or the default position of a ‘Browser’, a user who has yet to take either role of Publisher or Subscriber but may do so in the future. Whilst all users remain Browsers it is also an object of this invention that a user can play the role of both Publisher and Subscriber simultaneously. It is therefore another object of the System that any Publisher of a Monetized Broadcast, that may or may not have acquired their own Subscribers, may themselves also be a Subscriber of another Publishers Monetized Broadcasts. To put it another way, all Subscribers for information can be Publishers of information and visa versa.

It is another object of the invention to provide users the tools to discern which Publishers they should seek to receive Monetized Broadcasts from. Accordingly the information ecosystem provides the framework for the discovery of Publishers that Subscribers may choose to follow. The System allows bespoke discovery solutions through innovative ranking technology of a Publishers profile and other suitable metrics. Through the computer-based evaluation of user defined data and the incorporation of parameter defined rules, rankings and weightings of said data the present invention provided a system and method for a user to apply a ‘weight’ to the data and data sources of any other given user within the Information Ecosystem. The system then allows for the aggregation of the weighted data inputs from users creating a ranking of that data, a weighting-of-weighting, where in all user weightings of data are expressed in relation to each other.

It is a further object of the invention that the user can validate the Monetized Broadcasts against a database to confirm the accuracy of the Monetized Broadcasts. The said database would allow the users to validate the accuracy and quality of the information received from a Publisher. An embodiment of this may be the use of various leaderboards to allow the Browser a cross comparison tool for the discovery of a Publishers track record in relation to other Publishers.

A further object of the invention is to allow a validated Subscriber to, track and manipulate the data of any Publisher that they are subscribed once they have received the Monetized Broadcasts of a Publisher.

It is yet another object of the invention that a reciprocal relationship of payment and access is engendered between users—A relationship where the Subscriber access to a Publishers Monetized Broadcasts are balanced out by the Publisher receiving a monetary compensation. These reciprocal flows of payment and information is initialized, stored and processed by the System Server.

It is yet another object of the invention that all subscriptions and Monetized Broadcasts are received and activated by the system in real-time giving Subscribers instantaneous access to a Publishers broadcast history, extended profile information and future Monetized Broadcasts.

Another object of this invention is that the System manages the payment of subscriber related fees to the respective Publisher. The System has predefined commission structures that are agreed with Publishers and in the event that a Publisher is due payment in respect of fees earned the System automates payment of these as they fall due for payment.

A core element of the invention is that the users constitute a social network. A social networked Information Ecosystem facilitates the discovery of Publishers to subscribe to. This is provided through a plurality of search and communication tools that allow for the searching, ranking and categorization of a Publisher and any historic Monetized Broadcast information. The searching, ranking and categorization of a user by the system may be benchmarked against ‘real-world’ outcomes, other users within the Information Ecosystem or any other data-point that the system determines as relevant or useful.

This invention may be utilized in many forms and any embodiment should only be limited by the scope of the claims. It is envisaged that embodiments of this invention may include, but are not limited to, financial and sporting related fields.

### BRIEF DESCRIPTION OF THE DRAWINGS

FIG. 1 is a diagram illustrating an embodiment of the present invention.

### DETAILED DESCRIPTION OF THE INVENTION

As will be appreciated by one of the skill in the art, the present invention may be embodied as a Method, System and Computer Program.

This present invention discloses a real-time ecosystem for the commercialized collection & distribution of information messages over a network. This invention Method, System and Computer Program monetizes the flows of information between disassociated users through the active brokering of payment and information relationships between the users.

In one embodiment, the System of the invention allows visitor to register as a user through the following process: 1. The visitor enters the System through a mobile network device 2. Visitor clicks on “Sign Up”3. The graphical user interface then relays a registration request to a Registration module 4. Visitor provides the Registration module 115 with an email address, password and user name.

The Registration module 115 transmits the information provided by the user to Registered profile management module 117 to activate the account.

After registration of a user a Registered account module 118 performs various operations involved with (a) initializing and terminating subscription relationships between users (b) Authorizing PayPal (or similar) requests and authorizations (c) Automated depositing of funds to a users PayPal account.

A Registered profile management module 117 is a module that manages a users profile and performs various tasks including (a) Registration of new users, (b) create, delete and modify user profiles (c) Automatically distributing a Publishers Monetized Broadcast to their verified Subscribers (d) displaying various information to a user about other users whom they are in subscription relationships with (e) displaying the global ranking and other associated data regarding a users position in relation to all users in the ecosystem.

Once a user decides to contribute a Monetized Broadcast to the system he inputs the data through a graphical user interface of the system. The Monetized Broadcast is then pushed to a Routing Engine 112 before the Registered Profile Management module 117 distributes it to all the Publisher's verified Subscribers.

Further provided is an Account Management module 119 that allows a user to (a) view all their subscription relationships and manage the status of those to whom they subscribe. (b) Set-up and amend any PayPal or similar account to be linked to the user account.

A verified Subscriber can log in and view a Publishers recent and historical Monetized Broadcasts at any time. The invention will allow access to various data driven information sources so that the users can verify the merit/value of a Publishers Information Broadcasts. In contrast, a Browser (a non subscribed user) will only have access to a limited information bio of another user and will not be able to see a historical record of any of their Monetized Broadcasts and other associated data.

The Routing Engine 112 module processes live Monetizable Broadcast Events 110 that are received from Publishers and associates them with any verified Subscriber(s) before pushing the data alert to the Subscribers account as a Monetized Broadcast Transmission 111 indicating that a Monetized Broadcast Event 110 has occurred.

This invention envisages that the system will aggregate all a Subscribers received Monetized Broadcast through a Monetized Broadcast Aggregator module 120 in order to create a timeline of broadcast from all their Publishers. This invention envisages that other external news flow, blogs, infographics and other data from web syndicated sources.

A further object of this invention is that the System will dynamically rank the users via various metrics through a Ranking module 121 set within certain parameters. The System will Rank users in relation to the information that can be verified within the Monetized Broadcasts and/or any other criteria that the System decides. In a further embodiment the system may rank other data providers in the same way.

The disclosed invention also incorporates the key aspect that whilst a relationship exists between users in respect the creation, transmission and consumption of Monetized Broadcasts the architecture of the system is such that the payment relationship between Publishers and Subscribers is a disassociated one, where recurring payments paid by Subscribers are maintained by the System but are not directly linked to any Publisher.

In another embodiment of this invention, a Payment Status Verification module 116 exists that detects cessation of recurring or regular payments from one or more of the supported payment transaction mediums. The detailed description of the verification logic is specific to each payment medium. As an example, all payments arising from Apple's App Store, this verification is done by means of scheduled interaction between the System's Payment Status Verification module 116 and Apple's digital product receipt verification servers. The specific means of determining a lapsed or expired subscription varies from payment medium to payment medium, but in all cases the mechanism for detection of cessation of payment is by means of a scheduled interaction between the System's servers and external servers maintained by the operators of the payment medium. When a cessation of recurring payments are detected, the Payment Status Verification module 116 initiates a termination of a randomly assigned (by use of standard programming library random number routines) or heuristically determined (by various ranking or sorting algorithm) Publisher-Subscriber relationship. It is noteworthy that the terminated Publisher-Subscriber relationship may not be (indeed is likely not to be) the Publisher-Subscriber relationship that the user intended to terminate when he or she initiated the termination of the recurring payment.

In another embodiment of this invention, specific user interface has been designed to allow users to manage their Publisher-Subscriber relationships. This interface is necessitated by the disassociated nature between financial transactional data and Publisher-Subscriber data in the invention's data model, and by the random or algorithmic nature of selection of Publisher-Subscriber relationships for termination by the Payment Status Verification module 116. In this user interface, users may elect to override the terminated Publisher-Subscriber relationship and replace it with a different relation to terminate. The specific user interface elements used to accomplish this may include listboxes, lists, checkboxes and confirmation dialogs.

Another aspect of this invention relates to the weighting of data generated by users on in the Information Ecosystem, allowing for data to further aggregated, mapped, converted and apportioned through various user defined rules based algorithms. Each user may attach a value to each piece of data or data provider (other users) which in turn curates data in a way that best reflects the value of that data to the individual user. As new data is received form various sources the system ‘learns’ how a user is likely to weight the data and allocates a value for the data based on a users previous preferences. This process is then replicated at the meta-data level and a weighting-of-weighting is produced which reflects an aggregate of all weightings of data by all users in the Information Ecosystem. This information may be used in various ways including providing discovery tools for users with similar weighting preferences and providing overarching trending information on how the community values specific data.

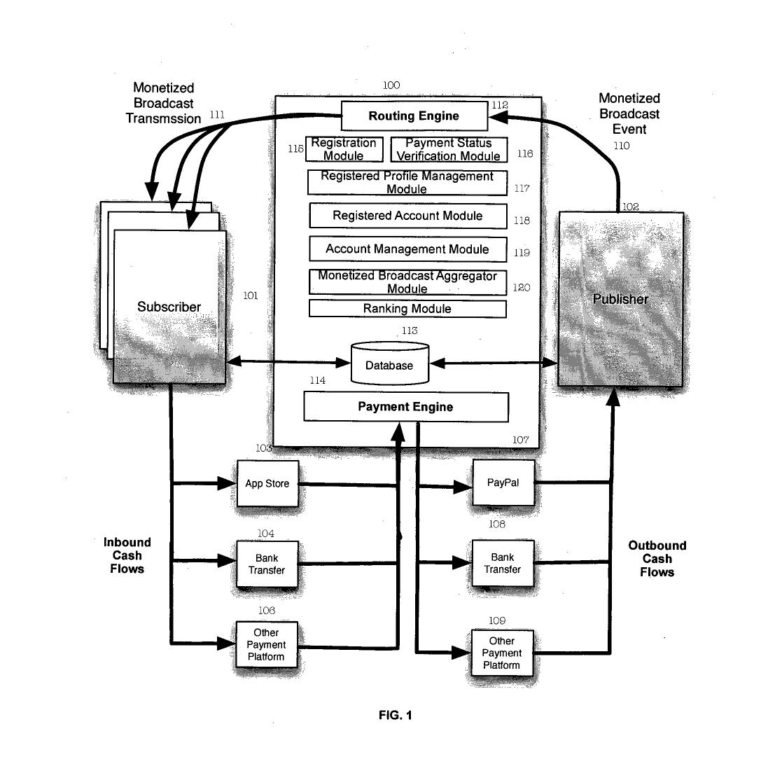

Reference is now made to FIG. 1, which discloses a basic configuration for the commercialized collection and distribution of Monetized Broadcasts and as such discloses a typical embodiment of the invention. An Information Brokerage System 100 is shown. The System 100 includes Publishers 102 who create content and publish them as Monetizable Broadcasts these are brokered by the System through a Routing Engine 112 to verify who subscribes for the broadcast before transmitting to the verified Subscribers 101. The System handles the disassociated recurring payment processing flows received as inbound cash flows from Subscribers 102 through a Payment Engine 114. This payment is received through various payment transaction mediums including the App Store 103, Bank Transfer 104 and any Other 106 that are similar. Publishers 102 receive payment from monies received from Subscribers 101 but remain dissociated from any financial relationship, with the System again acting as broker. Publishers receive payment through the Payment Engine 114 that makes an outbound cash transfer of a predetermined amount to Publishers 102 via PayPal 107, Bank Transfer 108 and any Other 109 that the System allows. In addition to the publishing, transmission and receipt of Monetizable Broadcasts the users may access various information data of other users through the System Database 113.

It will be appreciated by persons skilled in the art that the present invention is not limited by the particular embodiments outlined and described above. The features of the invention may be combined and recombined in various ways as well as any modifications and elaborations that someone skilled in the art may conceive. Examples of such embodiments include, but are not limited to, stocks and shares, football betting odds, outcomes in sports events and foreign exchange rates.

1-23. (canceled)

24. A system comprising
a routing engine configured to operatively couple at least one publisher with one or more subscribers, wherein the publisher is configured to create content that is published and/or brokered by said system as monetizable broadcasts for said one or more subscribers;
a payment engine configured to process payments from said one or more subscribers to said at least one publisher such that said one or more subscribers are disassociated from any financial relationship with said at least one publisher.

25. The system of claim 24, wherein said system further comprises an account management module configured to enable said at least one publisher to view its subscription relationship with said one or more subscribers.

26. The system of claim 24, wherein at least one of said one or more subscribers associates a weight with at least one of said monetizable broadcasts, wherein said weight is based on any or a combination of quality of said monetizable broadcasts, relevancy of said monetizable broadcasts, length of said monetizable broadcasts, value addition provided by said monetizable broadcasts, and one or more attributes of said monetizable broadcasts.

27. The system of claim 24, wherein said system further comprises one or more non-subscribed users to view at least a part of said monetizable broadcasts.

28. The system of claim 24, wherein said system publishes said content as monetizable broadcasts in real-time.

29. The system of claim 24, wherein said system further comprises a monetized broadcast aggregator module configured to aggregate monetizable broadcasts from multiple publishers to create a timeline of broadcasts, and wherein multiple illustrative representations are generated based on said timeline.

30. The system of claim 24, wherein said system further comprises a ranking module configured to dynamically rank one or more publishers based on one or a combination of respective content, feedback from one or more respective subscribers, percentage of plagarism, frequency of content generation, revenue generated by each publisher, and publisher specific attributes.

31. The system of claim 24, wherein the system further comprises a payment status verification module configured to enable said publisher to verify payment received thereby based on subscription status.

32. The system of claim 31, wherein the payment status verification module is further configured to detect termination of subscription by at least one of said one or more subscribers, and update the payment flows back to the publisher based on such detection.

33. The system of claim 24, wherein at least one of the one or more subscribers is also a publisher.

34. The system of claim 24, wherein said system enables validation of one or more of said monetizable broadcasts based on a database to evaluate accuracy thereof.

35. A method comprising the steps of:
coupling at least one publisher with one or more subscribers, wherein the publisher is configured to create content that is published and/or brokered by said system as monetizable broadcasts for said one or more subscribers;
processing payments from said one or more subscribers to said at least one publisher such that said one or more subscribers are disassociated from any financial relationship with said at least one publisher.

36. The method of claim 35, wherein said method further comprises the step of enabling said at least one publisher to view its subscription relationship with said one or more subscribers.

37. The method of claim 35, wherein at least one of said one or more subscribers associates a weight with at least one of said monetizable broadcasts, wherein said weight is based on any or a combination of quality of said monetizable broadcasts, relevancy of said monetizable broadcasts, length of said monetizable broadcasts, value addition provided by said monetizable broadcasts, and one or more attributes of said monetizable broadcasts.

38. The method of claim 35, wherein said method further comprises the step of enabling one or more non-subscribed users to view at least a part of said monetizable broadcasts.

39. The method of claim 35, wherein said method further comprises the step of publishing said content as monetizable broadcasts in real-time.

40. The method of claim 35, wherein said method further comprises the step of aggregating monetizable broadcasts from multiple publishers to create a timeline of broadcasts, and wherein multiple illustrative representations are generated based on said timeline.

41. The method of claim 35, wherein said method further comprises the step of dynamically ranking one or more publishers based on one or a combination of respective content, feedback from one or more respective subscribers, percentage of plagarism, frequency of content generation, revenue generated by each publisher, and publisher specific attributes.

42. The method of claim 35, wherein the method further comprises the step of a enabling said publisher to verify payment received thereby based on subscription status.

43. The method of claim 42, wherein the method further comprises the step of detecting termination of subscription by at least one of said one or more subscribers, and update the payment flows back to the publisher based on such detection.
